(19) United States
(12) Patent Application Publication
(10) Pub. No.: US 2008/0161737 A1
(43) Pub. Date: Jul. 3, 2008

(54) Serum Dispensing and Massage Device

(75) Inventor: Sharon Hilditch, Liverpool (GB)

Correspondence Address: BOYLE FREDRICKSON S.C., 840 North Plankinton Avenue, MILWAUKEE, WI, 53203, US

(73) Assignee: CRYSTAL CLEAR INTERNATIONAL LIMITED, Liverpool (GB)

(21) Appl. No.: 11/958,927

(22) Filed: Dec. 18, 2007

(30) Foreign Application Priority Data
Dec. 19, 2006 (GB) 0625265.4
Oct. 30, 2007 (GB) 0721263.2

(51) Int. Cl. A61H 7/00; B67D 1/07; B05B 7/00

(52) U.S. Cl. 601/135; 601/134; 222/192; 222/630

(57) ABSTRACT

A device dispenses serum onto the skin of a user and also provides a massage effect. The device comprises a hand-held housing and at least two massage head assemblies. A powered drive is mounted by or in the housing and is operatively coupled to the massage heads to cause them to execute a massage motion. The device has at least one serum dispensing outlet and a pump mechanism, comprising a piston and a cylinder, arranged to draw serum from a reservoir and to dispense it through the dispensing outlet. A user-actuatable member is movably mounted upon the housing and operatively coupled to the piston, so that via the user-actuatable member, the user can move the piston to cause a dose of serum to be dispensed.

### BACKGROUND OF THE INVENTION

1. Field of the Invention

The present application relates to a device which dispenses serum onto the skin of a user and provides a massaging effect. It is particularly suited to cosmetic use, improving the appearance and health of the skin of a user and particularly of the facial areas.

2. Description of the Related Art

There are certain known devices which massage the skin whilst dispensing a lotion or massage oil. Canadian patent application CA215832A, for example, concerns a somewhat complex massaging device having a set of rotating brushes and an electrically driven pump for supplying a massaging substance to the brushes at controllable intervals. Published Japanese application 2004121327 describes a “treatment probe” which is adapted to release a solution through a vibrating head.

Other devices do not use a powered drive as such, but use freely movable balls or rollers for dispensing of a liquid onto the skin. A conventional dispenser for underarm deodorant, or massage oil uses such a ball arrangement and further examples can be found in GB2194152, EP1472953 and GB2374045.

Alternatively, there are devices that do not use a power drive, but use a hand-driven, twisting mechanism for releasing a lotion onto the skin. Such a device is taught in GB2404370, which also provides a massager located at the opposite end to the twist operated lotion dispenser. US20060072963 provides a twist up pen type dispenser comprising a brush applicator that is capable of receiving material from a reservoir.

WO-A-97/22326 discloses a massaging appliance for dispensing a massage cream which includes a cream dispenser unit attachable to the appliance housing and coupled to a rotary motor therein to be rotated thereby, and a non-rotatable rod within the appliance housing axially displaceable towards and away from the dispenser housing to block its rotation, and thereby cause a piston within the dispenser housing, and while rotating therewith, to move axially towards an end wall in the dispenser housing, to force cream through dispenser openings therein.

U.S. Pat. No. 3,994,290 discloses a massage device including a rotatable containing a plurality of projecting spheres for engaging the skin and kneading the tissues therebeneath. The housing has a cavity therein for storing massaging fluid or lotion which is dispensed over and by the spheres. The massage device may be permanently or removably attached to a rotary drive unit or may be in combination with a fluid metering means contained in a rotary drive means.

U.S. Pat. No. 5,092,041 discloses a shaving device having a handle with an inner chamber for accommodating a shaving cream, a head connected with the handle and having a passage for supplying the shaving cream and massaging and vibration elements, brushes on the head for distributing the shaving cream discharged from the head over the skin of the user, and a shaving element on the head for shaving after the application of the shaving cream and container for refreshing and disinfection.

Our co-pending application GB0625265.4 discloses a device which dispenses serum onto the skin of a user, and which also provides a massage effect. It is particularly well suited to cosmetic use. The device comprises a housing which is to be hand held and a massage head. A powered drive is mounted by the housing and operatively coupled to the massage head to cause it to execute a massage motion. Preferably, the massage motion is rotary. The device has at least one serum dispensing outlet and a pump mechanism, comprising a piston and a cylinder, arranged to draw serum from a reservoir and to dispense it through the dispensing outlet. A user-actuatable member, preferably formed by the massage head itself, is movably mounted upon the housing and operatively coupled to the piston, so that by means of the user-actuatable member the user can move the piston and so cause a dose of serum to be dispensed.

### OBJECT OF THE INVENTION

The present invention is intended to provide a constructionally simple but effective device for applying cosmetic fluid to the skin, and for providing a powered massage effect. In this context it is particularly important that the user should be able to control output of the cosmetic fluid in a straightforward manner.

In accordance with a first aspect of the present invention, there is provided a hand held serum dispensing and massage device comprising a housing, a serum reservoir carried by the housing, a plurality of massage heads which are mounted upon the housing and which are contactable with skin of a user, at least one power drive which is mounted by or in the housing and which acts upon the massage heads to cause them to execute a massage motion, and at least one serum dispensing outlet in each massage head, the device further comprising at least one pump mechanism which comprises a piston and a cylinder and is arranged to draw serum from the serum reservoir and dispense it through the dispensing outlet, and a user-actuatable member movably mounted upon the housing and operatively coupled to the piston so that by means of the user actuatable member the user can move the piston and so cause a dose of serum to be dispensed.

Preferably, at least one of the massage heads forms the user actuatable member. In accordance with a second aspect of the present invention, there is provided a hand held serum dispensing and massage device comprising a housing, at least one serum reservoir carried by the housing, a plurality of massage heads which are mounted upon the housing and which are contactable with skin of a user, a powered drive which is mounted by or in the housing and which acts upon the massage heads to cause them to execute a massage motion, and at least one serum dispensing outlet in each massage head, the device further comprising a pump mechanism which comprises a piston and a cylinder and is arranged to draw serum from the serum reservoir and dispense it through the dispensing outlets, and at least one user-actuatable member, formed by one or more of the massage heads themselves, movably mounted upon the housing and operatively coupled to the piston so that by means of the user actuatable member the user can move the piston and so cause a dose of serum to be dispensed.

The result is a simple device in which the user exercises very direct control over dispensing of serum.

In one embodiment of the invention two massage heads are provided, side by side. Greater numbers of massage heads, such as three, four or five are also contemplated.

The massage motion preferably comprises a rotary motion, the massage heads being rotatably mounted on the housing. When the massage motion comprises a rotary motion, at least two of the massage heads preferably rotate in the same direction, whether clockwise or anticlockwise.

Counter-rotating massage heads are also contemplated.

When the massage motion comprises a rotary motion, the massage heads preferably rotate at substantially the same speed, although multi-speed rotation is also contemplated.

The massage heads may be coupled to the housing in a manner which permits at least one of them to be depressed relative to the housing to move the piston. Hence the user can cause serum to be dispensed merely by presenting the massage head(s) to the skin and exerting pressure, which is very convenient in use.

A return spring acting on the massage head(s) is preferably provided to return them to their normal position following depression.

In a particularly preferred embodiment, the pump mechanism comprises a first one way valve through which the cylinder communicates with the serum reservoir, the first one way valve being arranged to permit flow into the cylinder, and a second one way valve through which the cylinder communicates with the dispensing outlet, the second one way valve being arranged to permit flow out of the dispensing outlet, so that piston motion in one direction causes the cylinder to be filled from the reservoir piston motion in the opposite direction causes serum to be dispensed through the outlet.

The one way valves may be co-axial, circular diaphragm valves.

A particularly preferred embodiment of the present invention comprises a housing assembly and a head assembly, the head assembly comprising the serum reservoir, at least one massage head and pump mechanism and the housing assembly comprising the powered drive and the housing, the two assemblies being separately formed and the housing assembly being adapted to releasably receive the head assembly and to rotatably mount it, the powered drive having a rotary coupling member for coupling the powered drive to the head assembly, enabling the powered drive to rotate the head assembly relative to the housing.

This formation of the device as two separable assemblies is particularly advantageous. The head assembly may be a disposable unit, which is replaced when its serum reservoir runs dry. Hence an after sales market is provided for head assemblies. Head assemblies may for example be interchanged, to allow different types of serum to be used.

The manner of coupling the head assembly to the housing assembly preferably comprises complementary press fit features, so that the head assembly is able to be engaged with the housing assembly simply by pushing the press fit features together, and to be disengaged by pulling the press fit features apart.

In accordance with a second aspect of the present invention, there is provided a dual or multi-head assembly for use in a hand held serum dispensing and massage device, the head assembly comprising a serum reservoir, at least one serum dispensing outlet, a plurality of massage heads which are contactable with skin of a user, and a pump mechanism for propelling serum from the serum reservoir to the dispensing outlet, the massage heads being mounted in a manner which permits at least one of them to be depressed by the user, and being operatively coupled to the pump arrangement, so that by depressing the massage head the user causes serum to be dispensed.

Preferably the head assembly is adapted to be rotationally driven, having engagement features for engaging with a rotary drive. In such an embodiment, the head assembly may comprise a cylindrical cartridge forming the serum reservoir, at one end of which the massage head is mounted and at the other end of which the engagement features are formed.

It is desirable to exclude air from the serum reservoir, despite the fact that its contents will progressively reduce in volume during use. To this end, in a preferred embodiment, the serum reservoir is cylindrical and is bounded at one end by a piston, which moves when serum is withdrawn from the reservoir to correspondingly reduce the effective volume of the reservoir. The piston may simply be free to move in its cylinder, so that withdrawal of serum causes it to be propelled along the cylinder by excess external air pressure.

### BRIEF DESCRIPTION OF THE DRAWINGS

A specific embodiment of the present invention will now be described, by way of example only, with reference to the accompanying drawings in which:

FIG. 1 is a perspective illustration of a single-headed device in accordance with our co-pending application GB0625265.4;

FIG. 2 is a perspective illustration of the inner components of the single headed device of FIG. 1;

FIG. 3 shows the same device, major components being disassembled;

FIG. 4 is an exploded view of the device;

FIG. 5 is an exploded view of a head unit used in the device;

FIG. 6 is a perspective illustration of part of the head unit, cut away in both axial and radial planes to reveal interior detail;

FIG. 7 is a perspective illustration of parts of the device; and

FIG. 8 illustrates in schematic cross-section the multi-headed (in this case two-headed) device of the present invention.

### DETAILED DESCRIPTION OF THE PREFERRED EMBODIMENTS

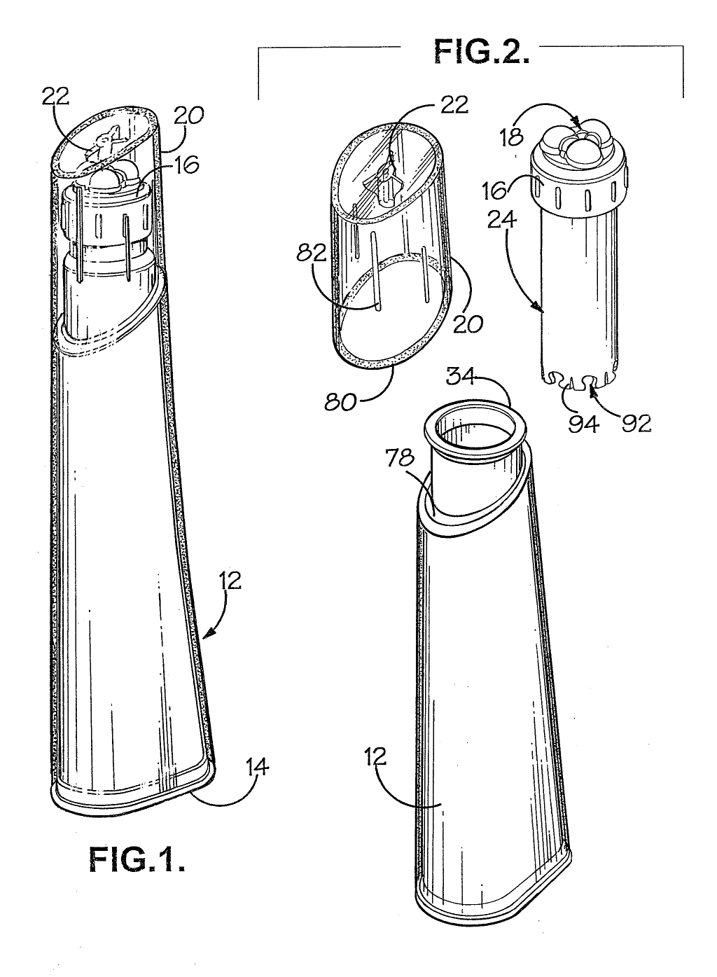

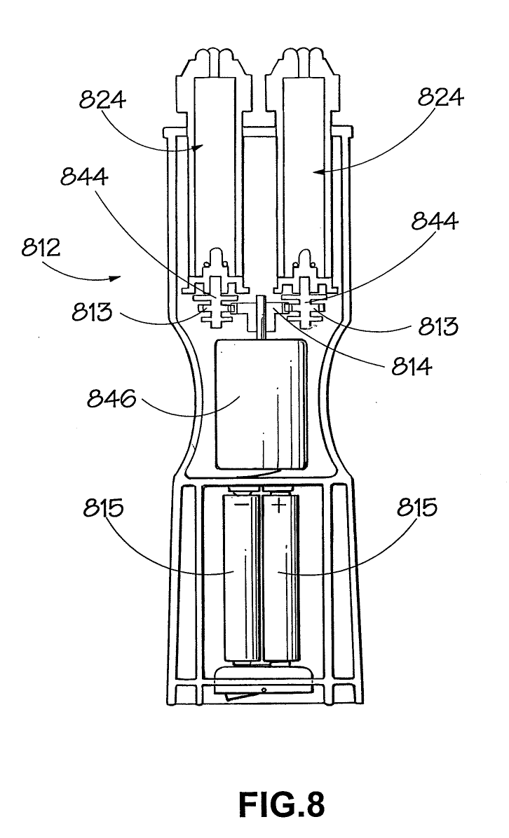

The drawings show a combined massage and serum dispensing device 10. It is particularly, but not exclusively, suited to treatment of facial areas around the eye. The device is battery powered and portable, such that it can be carried by the user in a small bag or similar. FIGS. 1 to 7 illustrate the single-headed device of our co-pending application GB0625265.4. However, much of the internal mechanism in the multi-headed device of the invention (illustrated in FIG. 8) is the same as, or not substantially different from, the single-headed device of FIGS. 1 to 7, and the head units in particular depicted in the drawings may be used in the FIG. 8 device substantially as shown, except of course that more than one head is deployed in the FIG. 8 device in accordance with the invention.

Referring particularly to FIGS. 1 and 2, the device 10 has an elongate main housing unit 12 which is shaped and proportioned to permit it to be comfortably hand held, having an oval cross section. Toward one end the main housing broadens to form a base 14, and at the other end it supports a rotary massage head 16.

By depressing the massage head 16, the user causes serum to be dispensed through an axial dispensing opening 18 formed in it (see FIG. 2). A removable cap 20 covers the massage head 16 when the device is not in use, and has an internal plug 22 which closes the dispensing opening 18 when the cap is in situ to prevent unwanted discharge of serum.

The device 10 comprises two principal assemblies, shown separately in FIG. 2. The first of these is head assembly 24 which, as will be explained below, forms a reservoir for the serum and comprises a user actuatable pump for dispensing it in a controlled manner. The entire head assembly 24, including the rotary massage head 16, is rotated during massaging. The head assembly 24 is intended to be disposable. Once empty of serum, it is discarded and replaced.

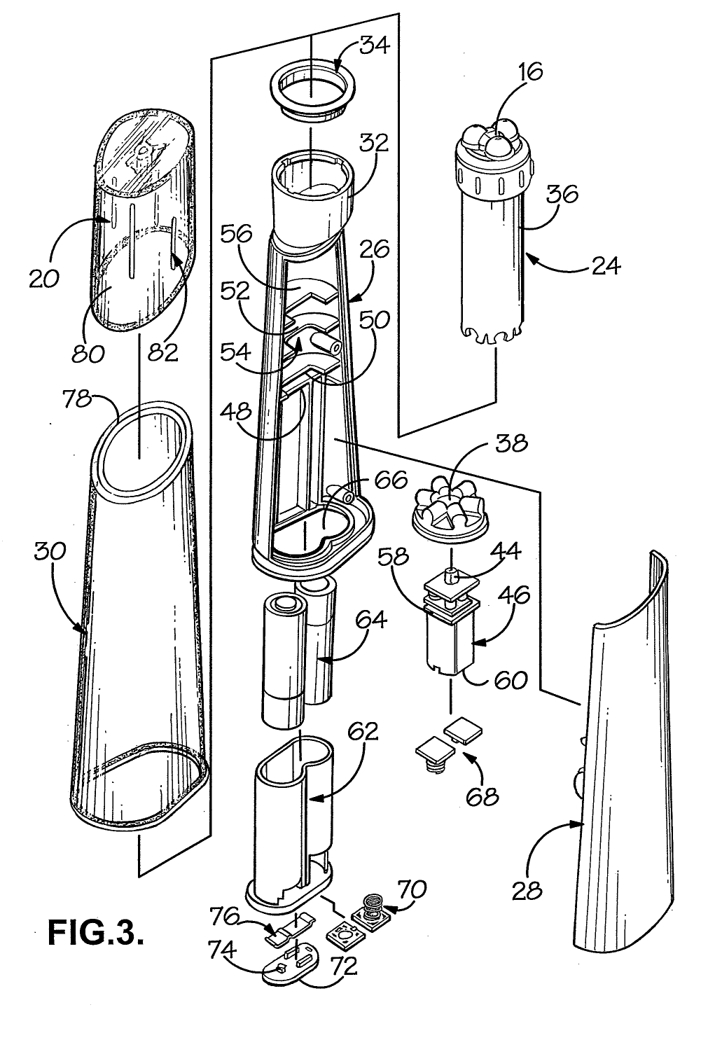

The second of the principal assemblies comprises the main housing 12 and its internal components, serving to rotatably mount and to drive the head assembly 24. This assembly will now be described with particular reference to FIG. 3.

The main housing 12 comprises first and second housing parts 26, 28, which are separable from each other along a longitudinal plane and are shaped to locate one upon the other, and an outer sleeve 30 which is slipped over the first and second housing parts and serves to retain them together. One end of the first housing part 26 is formed by an integral, annular collar 32 which receives an outer ring-bearing 34. In the assembled device, a cylindrical cartridge 36 of the head assembly 24 is received and journalled in the bearing 34.

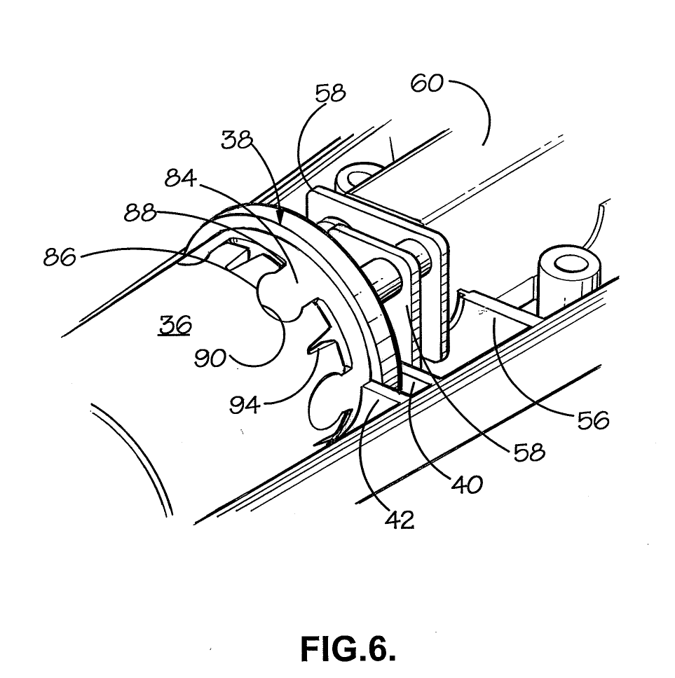

The base of the cartridge 36 is mounted, within the main housing 12, by means of a drive sprocket 38, captively mounted between retention features formed as integral, transverse ribs within the first and second housing parts 26, 28. Refer in this regard to FIG. 6. The drive sprocket 38 engages, in a manner which will be described below, with the base of the cartridge 36. The retention features comprise a thrust plate 40 at the rear of the drive sprocket 38 and a retaining collar 42 in front of it, serving together to axially locate both the sprocket and the head assembly 24. Axial loads due to pressure on the rotary massage head 16 in use are referred through the drive sprocket 38 to the thrust plate 40. The drive sprocket 38 is carried upon a drive shaft 44 of a motor/gearbox assembly 46 (FIG. 3). To mount this assembly, the first and second housing parts 26, 28 have integral internal transverse mounting ribs, specifically a rear mounting rib 48 with a shallow recess 50 to receive and locate the assembly's base, an intermediate mounting rib 52 with a cut away 54 to embrace the assembly's body, and a front mounting rib 56. Carrier plates 58 of the motor/gearbox assembly 46 are positioned between the front mounting rib 56 and the thrust plate 40 to axially locate the assembly. Reduction gearing is mounted between the carrier plates 58 to drive the shaft 44 from motor 60. Details of the gearing are not seen, but the assembly 46 is in this embodiment an “off the shelf” commercial item using a spur gear arrangement. In the present example the gearing provides a speed reduction of 30:1, to give a massage head speed of about 100 RPM depending on load. Batteries are housed in a base portion of the main housing 12. The present embodiment uses a battery carrier 62 shaped to receive two miniature cylindrical batteries 64. The battery carrier 62 is insertable into the main housing through an opening 66 in its base, to bring exposed end terminals of the batteries into abutment with respective sprung contacts 68 which in turn abut terminals (not seen) on the base of the motor 60. The circuit is completed through sprung contacts 70 within the carrier 62 and a switch formed at its base by a slider 72 carrying a stub 74 to selectively depress/release a sprung switch contact 76.

The cap 20 and sleeve 30 have, for the sake of appearance, inclined end faces 78, 80, but to releasably retain the cap it has shallow internal ribs 82 which are a “snap” fit on the rim of the ring bearing 34, which stands slightly proud (see FIG. 1).

The coupling between the drive sprocket 38 and the base of the cartridge 36 is best seen in FIG. 6. It forms a “snap” fit, allowing the cartridge 36 to be engaged by the user simply by pushing the head assembly home, and to be subsequently released by pulling on the massage head 16 with sufficient force.

This is achieved by means of interengaging male and female formations shaped such that insertion of the former into the latter requires some resilient deformation. Specifically, in the present embodiment, the drive sprocket 38 has on its front base a set of integrally formed protuberances 84 whose profile comprises an enlarged head 86 and a narrower waist region 88. The base of the cartridge 36 is formed with a corresponding set of cut outs 90 of approximately “u” shape, except that each narrows towards its open mouth (FIG. 2). The cartridge base is also cut away between each of the cut outs 90, as seen at 94, so that material defining the mouths 92 is able to deform resiliently, enabling the heads 86 to be inserted through the mouths 92, and then to snap back to retain the heads 86 in position. The arrangement is self centring.

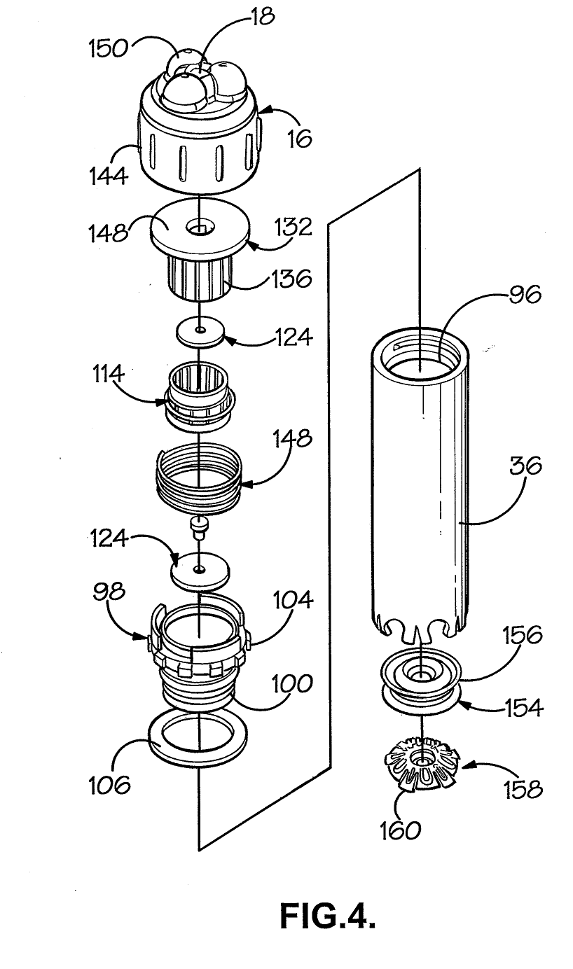

The interior of the head assembly 24 is best seen in FIGS. 4, 5 and 7. The assembly uses a variation of the vacuum pump principle to allow dispensing of serum from the reservoir cartridge 36 without losses due to ingress of air. As the reservoir empties, a series of one way valves ensures that its effective volume shrinks to the remaining serum volume. Unlike a gravity fed system, it will work in any orientation.

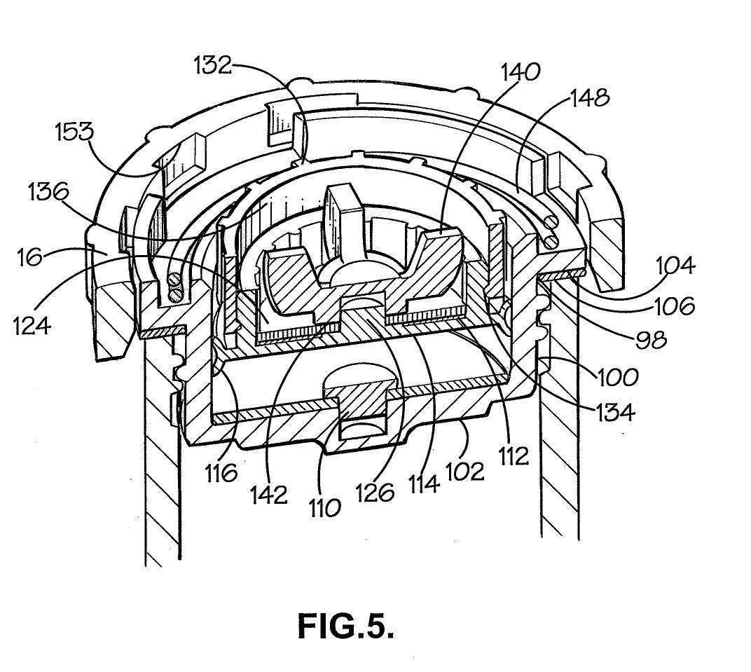

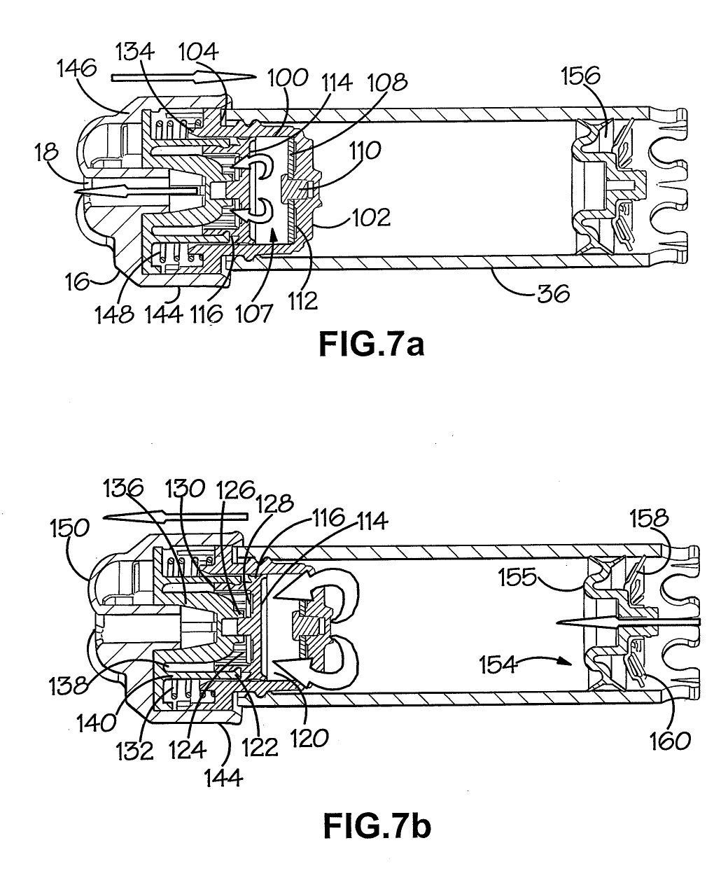

The mouth 96 of the cartridge 36 is internally threaded to receive an externally threaded pump housing 98 which comprises a cylinder portion 100, a base portion 102 lying across one end of the cylinder 100, and an outwardly turned, toothed, flange 104 at the end of the cylinder remote from the base (see FIG. 5 in particular). A sealing ring 106 is retained and compressed between the toothed flange 104 and a rim at the mouth 96 of the cartridge, to form a seal against egress of serum in this region. At the base of the pump housing, a first one way valve 107 is formed by means of a first diaphragm 108, retained in position by a mushroom headed peg 110 received as a press fit in a blind hole in the base 102 of the pump housing (see FIG. 7). Note that the inner surface of the base 102 is slightly relieved at 112, so that annular sealing surfaces are formed radially inside and outside this shallow relief, for the first diaphragm 108 to seat upon. Also, the annular space defined by this relief communicates with the interior of the cartridge 36 through openings in the base 102, which are not seen in the drawings.

Within the cylinder 100 of the pump housing 98 is a plunger 114. This serves the function of a piston within the cylinder. It has a circular base portion whose outer periphery is bifurcated at 116 to form two resilient, sealing contacts with the interior of the cylinder. This formation is well suited to manufacture in resilient plastics. The plunger 114 thus defines a working chamber 120 within the pump housing 98. Serum is able to enter this chamber via the first one way valve 107. The only route for serum to leave the working chamber 120 is via a second one way valve 122. This comprises a second diaphragm 124 retained upon a locating peg 126 which is integral with and upstanding from the base of the plunger 114. Note that the inner surface of the base of the plunger has a shallow relief at 128, beneath the second diaphragm 124, so that radially inside and outside this relief are formed seating surfaces against which the second diaphragm 124 forms a seal. The shallow relief 128 communicates with the working chamber 120 through holes in the base of the plunger 114, which are not seen in the drawings.

The plunger 114 has an integral upstanding annular wall 130 through which it is coupled to an actuator member 132. This coupling is achieved by means of a shallow external annular recess in the annular wall 130 of the plunger 114, which receives a complimentarily shaped internal annular projection 134 of a cylindrical body portion 136 of the actuator member 132. The two parts simply snap together during assembly, with some slight resilient deformation of each. At its end remote from the plunger, the actuator member 132 terminates in an end plate 138 having a through-going axial opening. Depending from this end plate are internal fingers 140 serving to mount a collar 142 which embraces the locating peg 126 and serves to retain the second diaphragm 124 in position. The actuator member 132 is coupled to—and serves as a carrier for—the massage head 16. A cylindrical shroud portion 144 of the massage head has a shallow radially extending ridge 146 which retains the end plate 138 against an internal end surface of the massage head. The shroud portion 144 covers, and is a sliding fit upon, outer surfaces of the pump housing 98. A return spring 148 is housed within the shroud portion 144 and serves to bias the assembly comprising the massage head 16, the actuator member 132 and the plunger 114 outwardly—i.e. away from the pump housing 98. The aforementioned assembly can however be moved in the opposite direction by pressure applied to the massage head 16. A passage for exhaustion of the serum is formed via the interior of the actuator member 132, leading to the dispensing opening 18.

The shape of the exposed outer surface of the massage head 16 is chosen to produce a desirable sensation for the user, and desirable therapeutic effects. It could in principle take any number of different forms, but in the present embodiment it comprises three semi-hemispherical projections 150 arranged around the dispensing opening 18. It is these projections which make contact with the skin of the user.

Since the entire head assembly 24 is rotated to transmit drive to the massage head 16, means are required to prevent relative rotation of the parts which couple the massage head 16 to the cartridge 36. Specifically, the massage head 16 has, as seen in FIG. 5, longitudinally extending internal trenches 153 which engage with the toothed flange 104 of the pump housing 98 to prevent relative rotation of these parts while accommodating longitudinal movement of the massage head.

At the end of the cartridge 36 remote from the massage head is a piston 154. This has a bifurcated formation 156 forming its outer periphery, to seal against the interior of the cartridge, and this formation is carried upon a wall having a “C” shaped return 155, to increase the resilience of the piston and ensure a good sealing fit. On its outer face the piston carries a non-return member 158 whose inclined arms 160 contact the interior wall of the cartridge 36 and permit movement of the piston 154 only in the direction toward the massage head 16—i.e. only in the direction which reduces the effective volume of the cartridge.

The operation of the device will now be explained.

The user brings the rotary massage head 16 into contact with an area of skin (e.g. around the eyes) and, by applying pressure, causes the massage head 16 to be depressed into the cartridge, dispensing serum through the opening 18 onto the skin and the massage head. As indicated by arrows in FIG. 7a, depression of the massage head 16, transmitted through the actuator member 132 to the plunger 114, reduces the volume of the working chamber 120 and so forces serum through the second one way valve 122 and hence out through the dispensing opening. When pressure upon the massage head is released, as indicated by arrows in FIG. 7b, it is returned to its original position by the spring 148. The plunger 114 thus moves to increase the effective volume of the working chamber 120, causing it to be filled from the main body of the cartridge by the first one way valve 107. As serum is drawn but of the main body of the cartridge 36, the consequent pressure reduction therein causes the piston 154 to advance, without admitting air into the cartridge 36. By switching on the electric motor 60, the user causes the massage head 16 to rotate and the head is then moved over the relevant skin area, providing a massaging effect. Further serum can be dispensed as necessary by repeated depression of the massage head 16. When empty, the entire head assembly 24 is simply removed, by drawing it out of the housing assembly, and replaced with a new head assembly. This is hygienic—those parts exposed to serum and to the skin of the user being replaced—and provides an after sales market for head assemblies.

The invention therefore relates to a device which dispenses serum onto the skin of a user, and which also provides a massage effect. It is particularly well suited to cosmetic use. The device comprises a housing 12 which is to be hand held and a massage head 16. A powered drive 46 is mounted by or in the housing and operatively coupled to the massage head to cause it execute a massage motion. Preferably, the massage motion is rotary. The device has at least one serum dispensing outlet and a pump mechanism, comprising a piston 114 and a cylinder 100, arranged to draw serum from a reservoir and to dispense it through the dispensing outlet. A user-actuatable member 116, formed by the massage head itself, is movably mounted upon the housing and operatively coupled to the piston, so that by means of the user-actuatable member the user can move the piston and so cause a dose of serum to be dispensed.

Referring to FIG. 8, there is shown a device 812 of substantially similar design to that shown in FIGS. 1 to 7, but incorporating two massage heads 824. Each head assembly 824 is of the same design as previously described. In the depicted arrangement, the drive shaft 844 of each massage head is operatively coupled by a gearing mechanism 813 to the gearing mechanism 814 of electric motor 846, powered in this case by twin batteries disposed in the housing. Operation of the device is otherwise substantially as described in relation to the single-headed device.

I claim:

1. A hand held serum dispensing and massage device comprising:
a housing,
a serum reservoir carried by the housing,
a plurality of massage heads which are mounted upon the housing and which are contactable with skin of a user,
at least one powered drive which is mounted on or in the housing and which acts upon the massage heads to cause the massage heads to execute a massage motion,
at least one serum dispensing outlet in each massage head, and
at least one pump mechanism which comprises
a piston,
a cylinder arranged to draw serum from the serum reservoir and to dispense it through the dispensing outlet, and
a user-actuatable member movably mounted upon the housing and operatively coupled to the piston so that, via the user actuatable member, the user can move the piston to cause a dose of serum to be dispensed.

2. A device according to claim 1 wherein each massage head is a user actuatable member.

3. A device according to claim 1 wherein two massage heads are provided.

4. A device according to claim 1 in which the massage heads are coupled to the housing in a manner which permits them to be depressed relative to the housing to move the piston.

5. A device according to claim 4 further comprising a return spring acting on the massage head to return it to its normal position following its depression.

6. A device according to claim 1 in wherein the pump mechanism further comprises
a first one way valve through which the cylinder communicates with the serum reservoir, the first one way valve being arranged to permit flow into the cylinder, and
a second one way valve through which the cylinder communicates with the dispensing outlet, the second one way valve being arranged to permit flow out of the dispensing outlet so that piston motion in one direction causes the cylinder to be filled from the reservoir and piston motion in the opposite direction causes serum to be dispensed through the outlet.

7. A device according to claim 1 wherein the massage heads are rotatably mounted upon the housing and the massage motion is rotary.

8. A device according to claim 7 wherein the massage heads rotate in the same direction.

9. A device according to claim 1 wherein the device comprises a housing assembly and a head assembly, the head assembly comprising the serum reservoir, massage heads and pump mechanism and the housing assembly comprising the powered drive and the housing, the two assemblies being separately formed and the housing assembly being adapted to releasably receive the head assemblies and rotatably to mount them, the powered drive having a rotary coupling member for coupling the powered drive to the head assemblies, thereby enabling the powered drive to rotate the head assemblies relative to the housing.

10. A device according to claim 9 wherein the coupling member and the head assemblies have complementary press fit features forming a releasable coupling so that the head assemblies are able to be engaged with the housing assembly by pushing the press fit features together and to be disengaged by pulling the press fit features apart.

11. A device according to claim 10 in which the housing assembly has at least one internal cavity into which the head assemblies are insertable to mount them.

12. A device according to claim 1 wherein a serum dispensing outlet is provided in each massage head.

13. A device according to claim 12 wherein the massage head communicates with the serum reservoir upon actuation of the user-actuatable member

14. A head assembly for use in a hand held serum dispensing and massage device according to claim 1, the head assembly comprising at least one serum reservoir, at least two serum dispensing outlets, at least two massage heads which are contactable with skin of a user, and at least one pump mechanisms for propelling serum from the serum reservoirs to the dispensing outlets, the massage heads being mounted in a manner which permits them to be depressed by the user, and being operatively coupled to the pump arrangements, so that by depressing the massage heads the user causes serum to be dispensed.

15. A head assembly according to claim 14 wherein the head assembly is adapted to be rotationally driven and has engagement features for engaging with a rotary drive.

16. A head assembly according to claim 14 further comprising at least one cartridge that forms the serum reservoir, at one end of the massage heads being mounted at one end of the cartridge, and the engagement features being formed at the other end of the cartridge.

17. A head assembly according to claim 14, wherein the pump mechanism further comprises
a first one way valve through which the cylinder communicates with the serum reservoir, the first one way valve being arranged to permit flow into the cylinder, and
a second one way valve through which the cylinder communicates with the dispensing outlet, the second one way valve being arranged to permit flow out of the cylinder, so that piston motion in one direction causes the cylinder to be filled form the serum reservoir and piston motion in the opposite direction causes serum to be dispensed through the outlet.

18. A head assembly according to claim 14 in which the serum reservoir is cylindrical and is bounded at one end by a piston which moves when serum is withdrawn from the reservoir to correspondingly reduce the effective volume of the reservoir.
